(19) United States
(12) Patent Application Publication
(10) Pub. No.: US 2023/0209229 A1
(43) Pub. Date: Jun. 29, 2023

(54) COMMUNICATION NETWORKS INCLUDING SERVING AREA BRIDGING CONNECTIONS AND ASSOCIATED METHODS

(71) Applicant: Cable Television Laboratories, Inc., Louisville, CO (US)

(72) Inventors: Luis Alberto Campos, Superior, CO (US); Zhensheng Jia, Superior, CO (US); Nicolas Joel Metts, Superior, CO (US); Curtis D. Knittle, Superior, CO (US); Isaac Elliott, Broomfield, CO (US); Ralph William Brown, Boulder, CO (US)

(21) Appl. No.: 18/176,236

(22) Filed: Feb. 28, 2023

Related U.S. Application Data
(62) Division of application No. 16/403,103, filed on May 3, 2019.
(60) Provisional application No. 62/666,224, filed on May 3, 2018.

(51) Int. Cl. H04Q 11/00

(52) U.S. Cl. CPC H04Q 11/0005; H04Q 11/0003; H04Q 2011/005; H04Q 2011/0043; H04Q 2011/0047; H04Q 2011/0039

(57) ABSTRACT

A communication network includes a first serving area, a second serving area, a network hub, one or more trunk optical cables, and a first bridging connection. The first serving area includes a first optical switch, a first optical node, and one or more first intra-serving-area (ISA) optical cables communicatively coupling the first optical node to the first optical switch. The second serving area includes a second optical switch, a second optical node, and one or more second ISA optical cables communicatively coupling the second optical node to the second optical switch. The one or more trunk optical cables communicatively couple the first and second optical nodes to the network hub, and the first bridging connection communicatively couples the one or more first ISA optical cables and the one or more second ISA optical cables.

### RELATED APPLICATIONS

This application is a divisional of U.S. patent application Ser. No. 16/403,103, filed on May 3, 2019, which claims benefit of priority to U.S. Provisional Patent Application Seri. No. 62/666,224, filed on May 3, 2018. Each of the aforementioned patent applications is incorporated herein by reference.

### BACKGROUND

Electrical cable, optical cable, and wireless transmission paths are commonly used to transmit communication signals. Electrical cables transit communication signals in an electrical domain, and optical cables transmit communication signals in an optical domain. Wireless transmission paths transmit communication signals in a radio frequency (RF) domain.

Communication networks often use two or more types of communication media to transmit data. For example, modern cable systems typically use (a) optical cable to transmit data between a headend and an optical node and (b) coaxial electrical cable to transmit data between the optical node and client nodes. As another example, modern telephone systems generally use (a) optical cable to transmit data between a central office and a remote terminal and (b) twisted-pair electrical cable to transmit data between the remote terminal and client nodes. Additionally, cellular wireless communication networks frequency use (a) optical cable to transmit data between a central packet core and a wireless base station and (b) wireless signals to transmit data between the wireless base station and user equipment (UE) devices.

### BRIEF DESCRIPTION OF THE DRAWINGS

FIG. 1 is a schematic diagram of a communication network including an optical node in each serving area.

FIG. 2 is a schematic diagram of a communication network including optical nodes deep in serving areas.

FIG. 3 is a schematic diagram of a communication network having a ring architecture.

FIG. 4 is a schematic diagram of a communication network having a ring-in-ring architecture

FIG. 5 is a schematic diagram of a communication network including serving area bridging connections, according to an embodiment.

FIG. 6 is a schematic diagram of another communication network including serving area bridging connections.

FIG. 7 is an expanded view of a portion B of FIG. 6.

FIG. 8 is an expanded view of a portion C of FIG. 6.

FIG. 9 is a block diagram of a network hub, according to an embodiment.

FIG. 10 is a schematic diagram of another communication network including serving area bridging connections, according to an embodiment.

FIG. 11 is a schematic diagram of a communication network including serving area bridging connections and two network hubs, according to an embodiment.

FIG. 12 is a flow chart illustrating a method controlling flow of data in a communication network, according to an embodiment.

### DETAILED DESCRIPTION OF THE EMBODIMENTS

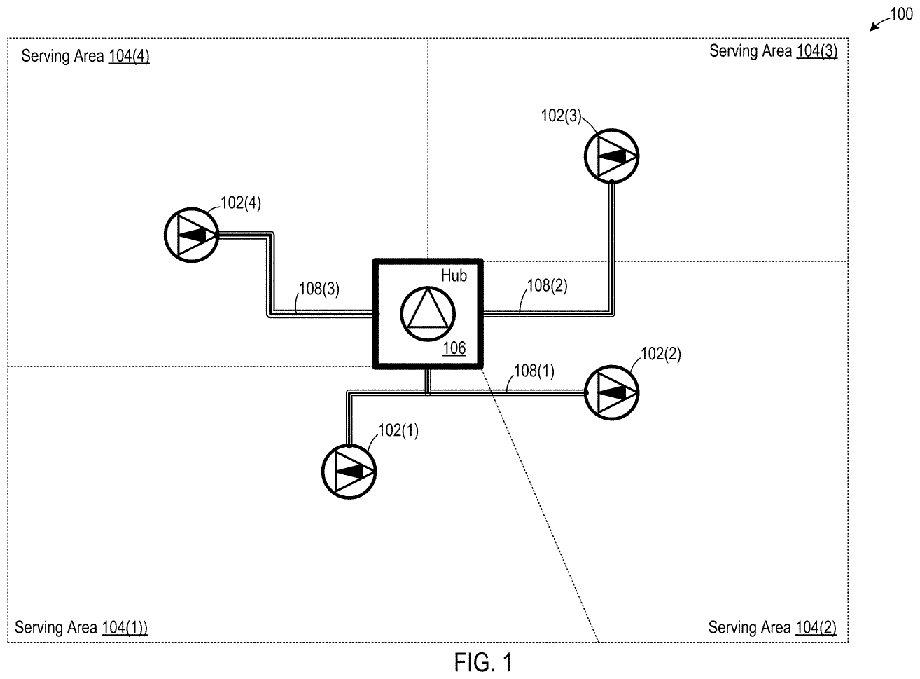

Communication networks previously used primarily electrical cables to carry data. For example, cable television networks historically used coaxial electrical cable to transmit data across an entire distance between a cable headend and a customer premises, and telephone networks historically used twisted-pair electrical cable to transmit data across an entire distance between a central office and a customer premises. In the 1980s and 1990s, subscriber growth and demand for high-bandwidth communication caused communication companies to implement many trunk lines with optical cable, instead of electrical cable, because an optical cable can carry multiple fiber strands and each fiber strand can carry many optical carriers or wavelengths which typically carry significantly more data over a long distance than an electrical cable. For example, FIG. 1 is a schematic diagram of a communication network 100 including a respective optical node 102 in each serving area 104. In this document, specific instances of an item may be referred to by use of a numeral in parentheses (e.g., optical node 102(1)) while numerals without parentheses refer to any such item (e.g., optical nodes 102).

Each serving area 104 represents a geographic area, such as a certain part of a city. Serving areas 104 typically include multiple buildings, such as homes and businesses, that are served by communication network 100. Serving areas 104 may also include non-building entities, such as wireless base stations, that are served by communication network 100.

Each optical node 102 is communicatively coupled to a hub 106 via a trunk optical cable 108. Specifically, trunk optical cable 108(1) communicatively couples optical nodes 102(1) and 102(2) to hub 106, and trunk optical cable 108(2) communicatively couples optical node 102(3) to hub 106. Additionally, trunk optical cable 108(3) communicatively couples optical node 102(4) to hub 106.

Hub 106 is, for example, a telecommunications central office, a cable headend, or a wireless network packet core. Each optical node 102 interfaces a trunk optical cable 108 with multiple electrical cables (not shown), such as twisted-pair electrical cables or coaxial electrical cables or wireless base stations or radios, in its respective serving area 104. Each electrical cable communicatively couples one or more client nodes (not shown), such as buildings and/or wireless base stations, with an optical node 102. Implementation of trunk cables 108 via optical cables in communication system 100 provides a high-bandwidth connection between each serving area 104 and hub 106, thereby helping support high-bandwidth applications in serving areas 104. Additionally, implementation of trunk cables 108 via optical cables eliminates the need to run electrical cables from each client node all-the-way to hub 106.

Although extension of trunk optical cable into serving areas, such as illustrated in FIG. 1, achieves significant benefits, modern communication applications may require more bandwidth than can necessarily be provided by electrical cables downstream from optical nodes. Therefore, communication companies have been deploying optical nodes deeper into serving areas, to increase the capacity per end point and reduce distance that data must travel via electrical cables in the serving areas.

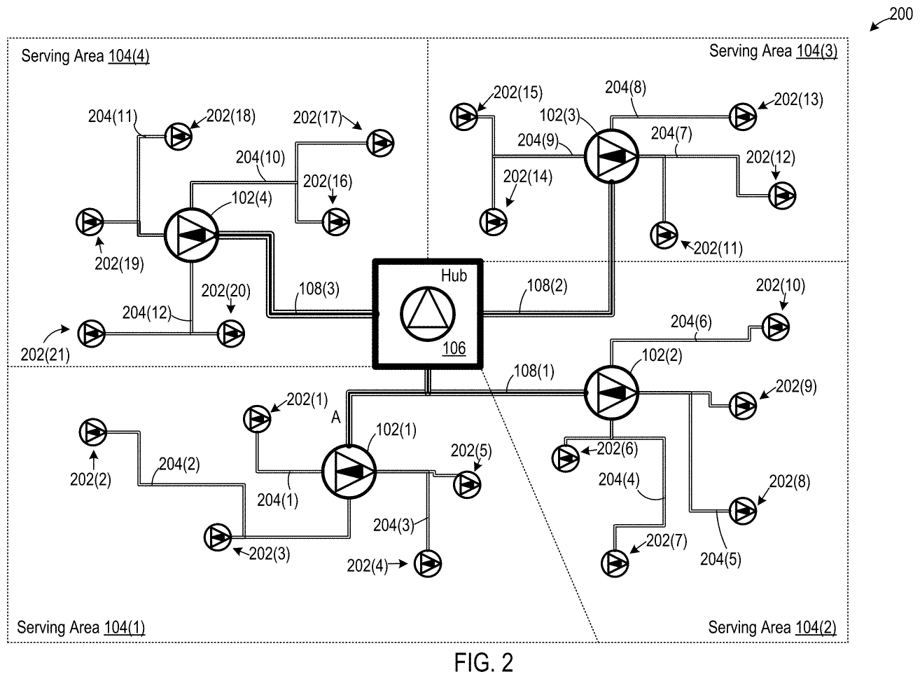

For example, FIG. 2 is a schematic diagram of a communication network 200 which is similar to communication network 100 of FIG. 1, but further includes optical child nodes 202 deep in each serving area 104. Each deep optical child node 202 is communicatively coupled to an optical parent node 102 via an intra-service-area optical cable 204. Each optical node child 202 interfaces an intra-service-area optical cable 204 with multiple electrical cables (not shown) in its respective serving area 104. Deployment of optical child nodes 202 deep in serving areas 104 segments the serving area and helps minimize distance that data must travel via electrical cables, thereby further helping provide high-bandwidth communication in the serving areas.

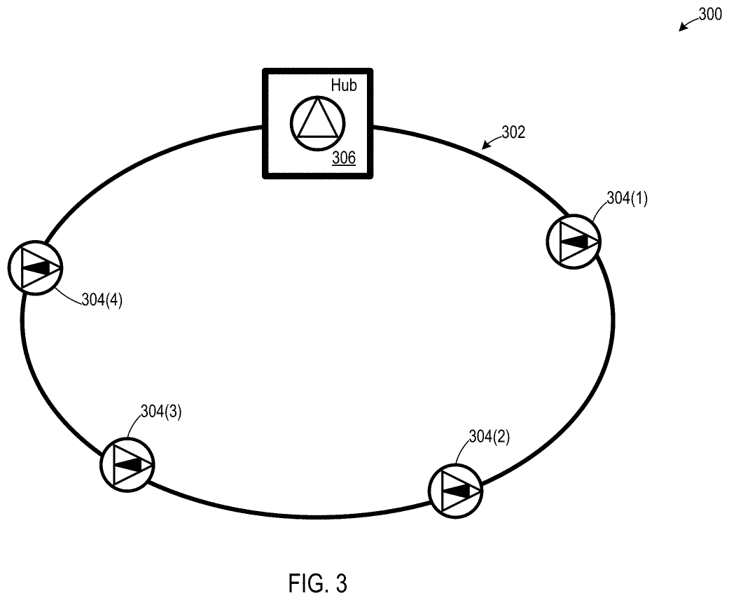

Communication networks with deep optical nodes are often not designed for redundancy. For example, assume that trunk optical cable 108(1) fails at point A in FIG. 2, such as due to the cable being cut. This failure will disrupt communication in the entirety of serving area 104(1), due to the non-redundant system topology in serving area 104(1). Redundancy can be achieved by implementing a ring architecture, where each optical node is communicatively coupled to an optical cable connected in a ring. For example, FIG. 3 is a schematic diagram illustrating a communication network 300 including a ring 302 of optical cable, where ring 302 communicatively couples multiple optical nodes 304 to a hub 306. Ring 302 provides two communication paths (e.g. clockwise and counterclockwise) for each optical node 304, and therefore, failure of the optical cable at any one point on ring 302 will not disrupt communication in communication network 300.

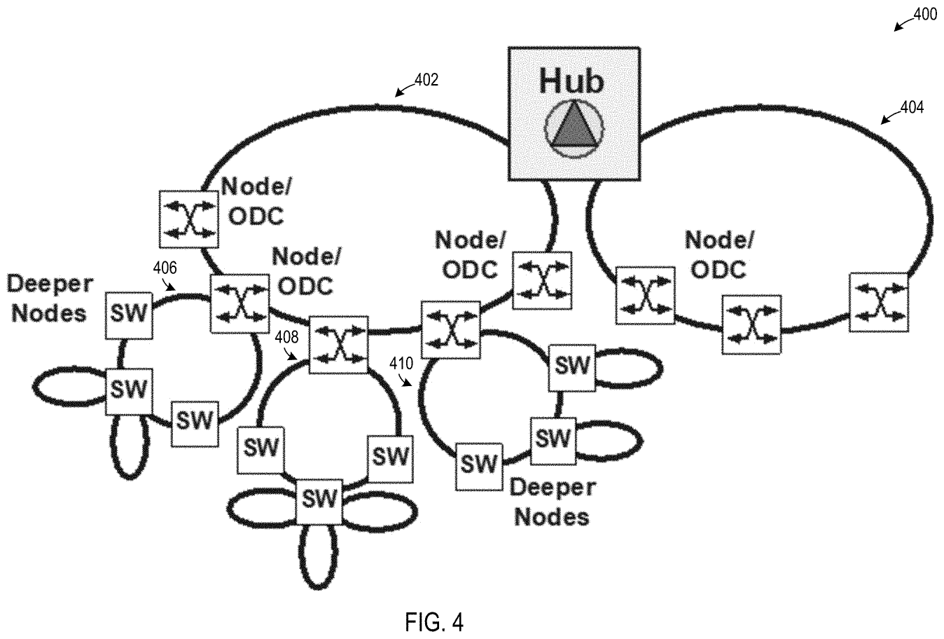

Fiber networks that already implement redundancy through fiber ring topologies and augment coverage by deploying fiber deeper, can add smaller fiber rings to enhance coverage. This architecture is called ring-in-ring architecture. For example, FIG. 4 is a schematic diagram illustrating a communication network 400 which implements a ring-in-ring architecture. Ring-to-ring translation devices such as optical switches, routers or reconfigurable optical add-drop multiplexers (ROADMS) are needed to transport traffic from a larger ring, e.g. 402 or 404, to a smaller ring, e.g. 406, 408, or 410. Processing in these translation devices adds latency and requires more power, in particular if the optical signals are to be translated from the optical domain to the electrical domain for processing to figure out where the signal is to be directed. This ring-in-ring architecture is hierarchical, the smaller rings always depend on its larger ring for their alternate or secondary path in case of connectivity failure. As capacity demand further increases, there is greater need for penetrating fiber deeper once more and another stage of smaller rings would be required along with the corresponding ring-to-ring translation devices. Such an approach requires a large number of ring-to-ring translation devices.

However, a ring-in-ring architecture has significant disadvantages in applications with many optical nodes in a serving area. In particular, multiple rings are generally required to achieved redundancy in serving areas with deep optical nodes, and these multiple rings may be costly and difficult to install. Additionally, translation devices are required to couple one ring instance to another ring instance, and these translation devices may be costly and may introduce undesired latency in data flow.

Disclosed herein are communication networks including bridging connections and associated methods which do not require a ring-in-ring architecture to achieve redundancy. The new communication networks include one or more bridging connections between communication system serving areas, thereby enabling data flow between serving areas, such as to achieve redundancy and/or load balancing. The bridging connections can often be relatively short, which promotes low-cost and ease of installation, because optical cables are present relatively near serving area edges in many applications. Additionally, the bridging connections may reduce, or even essentially eliminate, need to have excess network capacity to achieve redundancy. Furthermore, the bridging connections may achieve redundancy without introducing significant latency associated with translation devices of multi-ring architectures.

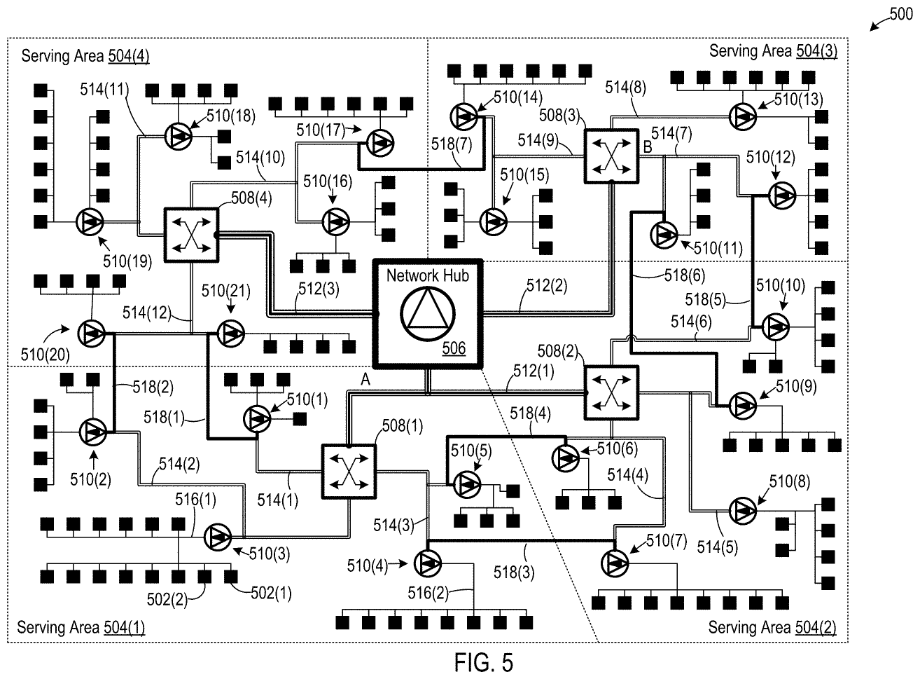

FIG. 5 is a schematic diagram of a communication network 500, which is one embodiment of the new communication networks including bridging connections. Communication network 500 provides communication services to client nodes 502 in a plurality of serving areas 504. Serving areas 504 are delineated by dashed lines in FIG. 5. Only two instances of client nodes 502 are labeled in FIG. 5 to promote illustrative clarity. Although client nodes 502 are served by communication network 500, client nodes 502 not part of communication network 500 in some embodiments. Each serving area 504 corresponds to a certain geographic area, such as a certain area of land or a certain portion of a building. Although FIG. 5 illustrates communication network 500 providing service to four serving areas 504, the number of serving areas 504 served by communication network 500 could vary without departing from the scope hereof. In some embodiments, serving areas 504 are non-overlapping, such as illustrated in FIG. 5. In some other embodiments, serving areas 504 may at least partially overlap, such to provide service to a critical client node 502 from two different serving areas.

Each client node 502 is, for example, a building, such as a home or a business, or a portion of a building, served by communication network 500. Client nodes 502, however, could be entities other than buildings, such as wireless base stations or connections to other communication networks. Additionally, each client node 502 could include multiple devices served by communication network 500. For example, a client node 502 could be an office building having many devices, such as multiple information technology devices, served by communication network 500. Each client node 502 need not have the same configuration. The number of client nodes 502 in serving areas 504 may vary without departing from the scope hereof

Communication network 500 includes a network hub 506, a plurality of optical switches 508, a plurality of optical nodes 510, a plurality of trunk optical cables 512, a plurality of intra-serving-area (ISA) optical cables 514, a plurality of electrical cables 516, and a plurality of bridging optical cables 518. One two instances of electrical cables 516 are labeled in FIG. 5 to promote illustrative clarity.

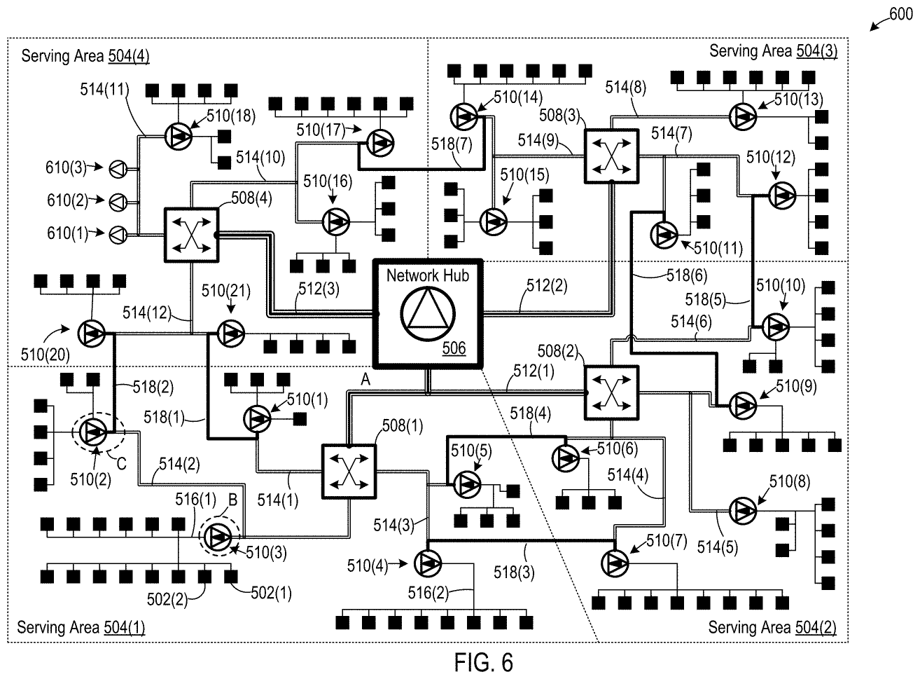

When new fiber is deployed through fiber deeper upgrades, it is advantageous to deploy fiber cable with large number of fiber strands. At the location of the parent node where few fiber strands connect to hub 506 and many more fiber strands are deployed to locations deeper, downstream from the parent node, optical switching functionality is advantageous. Functionality of the optical switches include fiber to fiber switching and specific wavelength routing from an input fiber to an output fiber. No translation to the electrical domain takes place in the optical switches in order to minimize delay and to have higher reliability. FIG. 5 shows optical switches 508 in locations where parent optical nodes 102 (FIGS. 1 and 2) where previously located. A larger number of fiber strands deployed from the parent optical node or the new optical switch to deeper child nodes 510, result in no additional switching functionality in the network beyond the optical switches 508 and the optical parent node locations, in certain embodiments. Therefore, hub 506 can reach any optical termination device 510 and 610 (FIG. 6) by traversing no more than a single optical switch 508.

Network hub 506 is a central network element of communication network 500. In some embodiments, network hub 506 includes one or more of a cable headend, a telecommunications central office, an optical line terminal (OLT), a wireless communication network core, and a converged communication core (e.g. supporting both wireline and wireless communication). In embodiments where network hub 506 supports wireless communication, network hub 506 optionally supports one or more of the following wireless protocols: a long-term evolution (LTE) wireless communication protocol, fifth generation (5G) new radio (NR) wireless communication protocol (e.g. licensed and/or unlicensed), a sixth generation (6G) wireless communication protocol, an unlicensed radio spectrum communication protocol (e.g. a Wi-Fi protocol), and extensions and/or variations thereof

Trunk optical cables 512 communicatively couple network hub 506 to optical switches 508. Specifically, trunk optical cable 512(1) communicatively couples each of optical switches 508(1) and 508(2) to network hub 506, trunk optical cable 512(2) communicatively couples optical switch 508(3) to network hub 506, and trunk optical cable 512(3) communicatively couples optical switch 508(4) to network hub 506. Each trunk optical cable 512 includes one or more optical fibers. In some embodiments, each trunk optical cable 512 includes one or more optical fibers dedicated to downlink data flow, and each trunk optical cable 512 includes one or more optical fibers dedicated to uplink data flow. In other embodiments, each trunk optical cable 512 includes one or more optical fibers which carry both uplink and downlink data. The number of optical switches 508, and the topology of trunk optical cables 512 communicatively coupling optical switches 508 to network hub 506, may vary without departing from the scope hereof. Communication network 500 optionally includes active and/or passive signal processing devices, including but not limited to amplifiers, repeaters, couplers, splitters, multiplexers, demultiplexers and/or taps, coupled to trunk optical cables 512.

ISA optical cables 514 communicatively couple optical nodes 510 to optical switches 508, as illustrated in FIG. 5. As their names suggest, each ISA optical cable 514 transmits data within a respective serving area 504. The number of optical nodes 510 and the topology of ISA optical cables 514 communicatively coupling optical nodes 510 to optical switches 508 may vary without departing from the scope hereof In some embodiments, each ISA optical cable 514 includes one or more optical fibers dedicated to downlink data flow, and each ISA optical cable 514 includes one or more optical fibers dedicated to uplink data flow. In other embodiments, each ISA optical cable 514 includes one or more optical fibers which carry both uplink and downlink data. Communication system 500 optionally includes active and/or passive signal processing devices, including but not limited to, amplifiers, repeaters, couplers, splitters, multiplexers, demultiplexers, and/or taps, coupled to ISA optical cables 514.

Electrical cables 516 communicatively couple client nodes 502 to optical nodes 510. In some embodiments, electrical cables 516 include one or more coaxial electrical cables, and in certain embodiments, one or more of the coaxial electrical cables are shared by two or more client nodes 502. In some embodiments, electrical cables 516 include one or more twisted-pair electrical cables, such as a respective twisted-pair electrical cable communicatively coupling each client node 502 to an optical node 510. Communication network 500 optionally includes active and/or passive signal processing devices, including but not limited to, amplifiers, repeaters, couplers, splitters, multiplexers, demultiplexers, taps, and/or load coils, electrically coupled to electrical cables 516.

Optical switches 508 are configured to route data streams between trunk optical cables 512 and ISA optical cables 514, and in some embodiments, optical switches 508 are configured to route data streams according to wavelength of the data streams. For example, in some embodiments, optical switches 508 are configured to route multiple data streams traversing a single optical fiber on trunk optical cables 512 to different respective optical fibers on ISA optical cables 514. Additionally, in some embodiments, optical switches 508 are configured to multiplex multiple data streams from different respective optical fibers of ISA optical cables 514 onto a single optical fiber of trunk optical cables 512. Furthermore, in certain embodiments, optical switches 508 are configured to route data streams between ISA optical cables 514 connected thereto, to enable data flow between ISA optical cables 514 without first traversing a trunk optical cable 512. In some embodiments, optical switches 508 are implemented at least partially using technology disclosed in U.S. Patent Application Publication No. 2018/0213305, which is incorporated herein by reference. In certain embodiments, optical switches 508 are controllable by network hub 506, such as to enable optical switches 508 to change topology of communication network 500 in response to an anomaly.

Optical nodes 510 are configured to translate data streams between ISA optical cables 514 and electrical cables 516. In some embodiments, optical nodes 510 include one or more of a cable fiber node, a telecommunications remote terminal, and a digital subscriber line access multiplexer (DSLAM).

Each bridging optical cable 518 communicatively couples an ISA optical cable 514 of one serving area 504 and an ISA optical cable 514 of another serving area 504. For example, bridging optical cable 518(1) communicatively couples ISA optical cable 514(1) of serving area 504(1) and ISA optical cable 514(12) of serving area 504(4). As another example, bridging optical cable 518(5) communicatively couples ISA optical cable 514(6) of serving area 504(2) and ISA optical cable 514(7) of serving area 504(3). The number of bridging optical cables 518 and their topology may vary without departing from the scope hereof, as long as communication network 500 includes at least one bridging optical cable 518. Additionally, bridging optical cables 518 could be replaced with alternative bridging connections, e.g. bridging electrical cables or bridging wireless links, without departing from the scope hereof.

Bridging optical cables 518 provide a path for data to flow between serving areas 504. Consequently, bridging optical cables 518 help provide redundancy in communication network 500. For example, consider a hypothetical scenario where trunk optical cable 512(1) fails at point A. This failure would completely isolate serving area 504(1) from network hub 506, absent bridging optical cables 518. However, presence of bridging optical cables 518 provides for alternate data flow paths between serving area 504(1) and network hub 506, and in particular embodiments, optical switches 508 can change topology of communication system 500 to implement these alternate data flow paths. For example, data can flow between optical node 510(4) and network hub 506 via (a) ISA optical cable 514(3), (b) bridging optical cable 518(3) and/or 518(4), (c) ISA optical cable 514(4), (d) optical switch 508(2), and (e) trunk optical cable 512(1). As another example, data can flow between optical node 510(3) and network hub 506 via (a) ISA optical cable 514(2), (b) bridging optical cable 518(2), (c) ISA optical cable 514(12), (d) optical switch 508(4), and (e) trunk optical cable 512(3). As yet another example, in embodiments where optical switch 508(1) is configured to route data between ISA optical cables 514, data can flow between optical node 510(3) and network hub 506 via (a) ISA optical cable 514(2), (b) optical switch 508(1), (c) ISA optical cable 514(1), (d) bridging optical cable 518(1), (e) ISA optical cable 514(12), (f) optical switch 508(4), and (g) trunk optical cable 512(3). Many more data flow paths incorporating bridging optical cables 518 are possible in communication network 500.

Accordingly, bridging optical cables 518 provide multiple redundant data flow paths in communication network 500, thereby promoting communication system reliability without requiring a ring architecture. Additionally, bridging optical cables 518 may help achieve high performance of communication network 500 by enabling load balancing, during both normal operation and in response to an anomaly, such as an unusually large load on communication network 500 or degraded operation of a portion of communication network 500. For example, consider a hypothetical scenario where there are no failures, but client devices 502 of serving area 504(3) are presenting a large load that cannot be adequately handled by trunk optical cable 512(2). In this scenario, network hub 506 and/or optical switch 508(3) may be configured to direct some data flow between serving area 504(3) and network hub 506 through serving areas 504(2) and 504(4) via bridging optical cables 518(5), 518(6), and/or 518(7), thereby helping relieve load on trunk optical cable 512(2).

Moreover, it should be appreciated that incorporation of bridging optical cables 518 into communication network 500 may help achieve redundancy and ability to balance load without necessarily requiring that communication network 500 have excess capacity, such as spare optical fibers. For example, if bridging optical cables 518 were not present, spare trunk optical cables 512 would be required to ensure redundancy in case of a trunk optical cable 512 instance being cut. Incorporation of bridging optical cables 518 in communication network 500, however, enables data to be routed around a failed trunk optical cable 512 without requiring a spare trunk optical cable 512.

Communication network 500 could be modified to include different types of optical nodes. For example, FIG. 6 is a schematic diagram of a communication network 600, which is similar to communication network 500 of FIG. 5 but where optical node 510(19) of serving area 504(4) is replaced with three instances of an optical node 610. In contrast to optical nodes 510, optical nodes 610 support only a single client node (not shown), and in some embodiments, each optical node 610 is an optical network terminal (ONT). The single client node is, for example, a single building, such as in a fiber-to-the-premises (FTTP) application. As another example, the single client node may be a wireless base station, such as a wireless base station operating according to a protocol including, but not limited to, a LTE wireless communication protocol, a 5G NR wireless communication protocol (e.g. licensed and/or unlicensed), a 6G wireless communication protocol, an unlicensed radio spectrum communication protocol (e.g. a Wi-Fi protocol), and extensions and/or variations thereof.

FIGS. 5 and 6 illustrate bridging optical cables 518 terminating at optical nodes 510, to help minimize number of connections in ISA optical cables 514. However, bridging optical cables 518 may connect to ISA optical cables 514 in other manners, e.g. away from optical nodes 510, without departing from the scope hereof

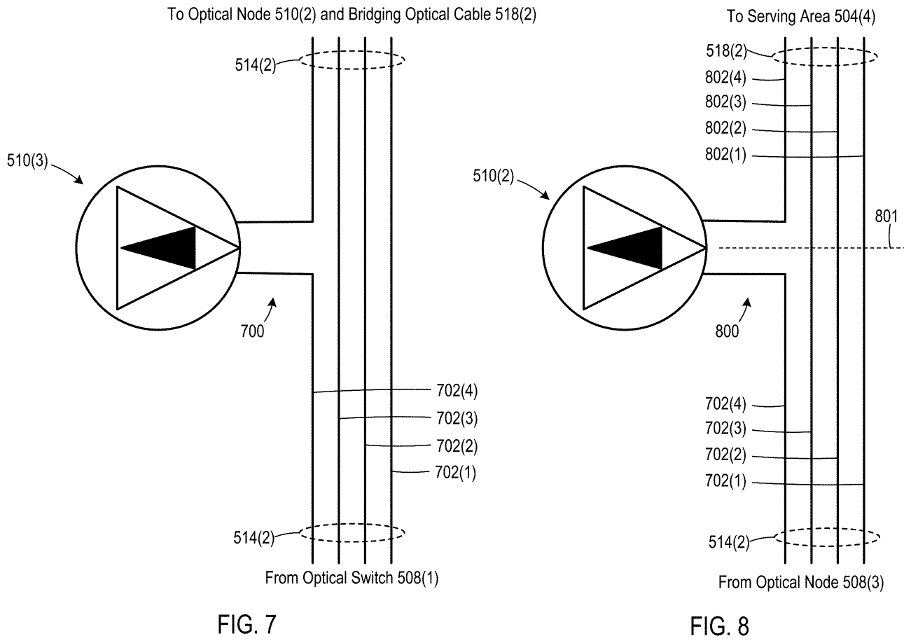

In certain embodiments, optical nodes 510 and 610 connect to ISA optical cables 514, or to an ISA optical cable 514 and a bridging optical cable 518, via a bidirectional drop. For example, FIG. 7 is an expanded view of a portion B of FIG. 6. FIG. 7 shows ISA optical cable 514(2) including individual optical fibers 702(1)-702(4), although the number of optical fibers 702 in ISA optical cable 514(2) could vary as a matter of design choice. Optical fiber 702(4) forms a bidirectional drop 700 connecting ISA optical cable 514(2) to optical node 510(3), such that a signal can flow from optical node 510(3) to either end of ISA optical cable 514(2) via optical fiber 702(4).

As another example of a bidirectional tap, FIG. 8 is an expanded view of a portion C of FIG. 6. A dashed line 801 represents a logical division between ISA optical cable 514(2) and bridging optical cable 518(2). However, in some embodiments, ISA optical cable 514(2) and bridging optical cable 518(2) are implemented by a common optical cable. Bridging optical cable 518(2) includes optical fibers 802(1)-802(4) corresponding to optical fibers 702(1)-702(4) of ISA optical cable 514(2), respectively. Optical fibers 702(4) and 802(4) collectively forms a bidirectional drop 800 connecting ISA optical cable 514(2) and bridging optical cable 518(2) to optical node 510(2), such that a signal from optical node 510(2) can flow to either ISA optical cable 514(2) or bridging optical cable 518(2).

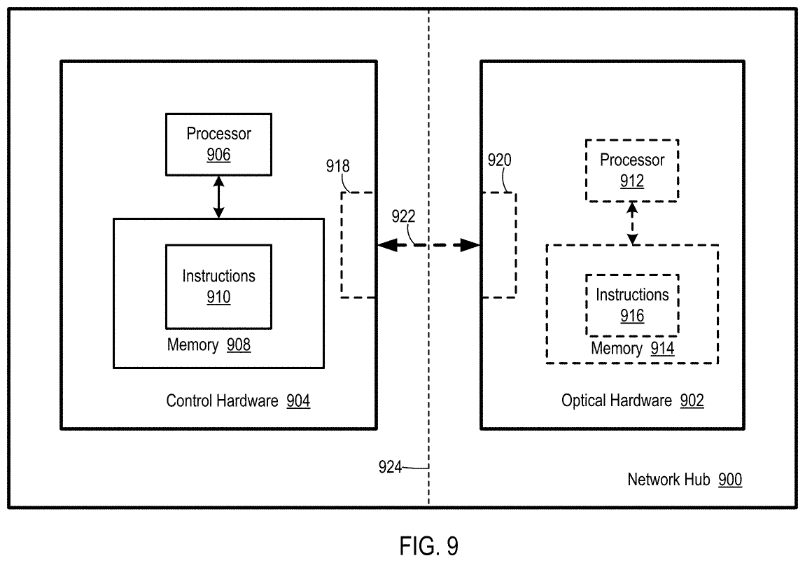

FIG. 9 is a block diagram of a network hub 900, which is one possible embodiment of network hub 506 of FIGS. 5 and 6. It should be appreciated, however, that network hub 506 could be implemented in manners other than that illustrated in FIG. 9. Network hub 900 includes optical hardware 902 and control hardware 904. Optical hardware 902 provides an optical interface to trunk optical cables 512. For example, in some embodiments, optical hardware 902 includes optical transmitters and receivers, as well as associated optical components, configured to translate signals between an optical domain and an electrical domain. Control hardware 904 controls optical hardware 902, and control hardware 904 optionally controls other functions of network hub 900. In some embodiments, optical hardware 902 and control hardware 904 at least partially implement one or more of a cable headend, a telecommunications central office, an OLT, a wireless communication network core, and a converged communication core.

Control hardware 904 includes a processor 906 and a memory 908. Processor 906 executes instructions 910 stored in memory 908 to control at least some functions of network hub 900. Instructions 910 are, for example, software and/or firmware. In some alternate embodiments, processor 906 and memory 908 are replaced by, or supplemented by, analog and/or digital electronic circuitry.

In some embodiments optical hardware 902 is configured to internally control at least some aspects of its operation. Accordingly, optical hardware 902 optionally includes a processor 912 and a memory 914, and in embodiments including these elements, processor 912 executes instructions 916 stored in memory 914 to control at least some aspects of optical hardware 902. Instructions 916 are, for example, software and/or firmware. In some embodiments, processor 912 and memory 914 are replaced by, or supplemented by, analog and/or digital electronic circuitry.

The elements of network hub 900 could be distributed among multiple locations. Additionally, the depicted elements in FIG. 9 could be combined and/or split without departing from the scope hereof. For example, processor 906 could be implemented by multiple processing devices located in different respective data centers, and memory 908 could be formed of multiple memory modules in one location or spread among multiple locations. As another example, optional processor 912 could be implemented by multiple processing devices located in different respective data centers, and optional memory 914 could be formed of multiple memory modules in one location or spread among multiple locations. As yet another example, optical hardware 902 could be split into two or more subsections, which are optionally disposed at different respective locations.

Additionally, network hub 900 could be configured to provide either distributed or centralized management. Distributed management is characterized by having respective control hardware 904 for each optical hardware 902 instance, while centralized management is characterized by control hardware 904 controlling multiple optical hardware 902 instances. In embodiments where network hub 900 provides centralized management, a communication path between control hardware 904 and optical hardware 902 is needed. Accordingly, control hardware 904 and optical hardware 902 optionally include respective communication interfaces 918 and 920. In these embodiments, a communication channel 922 provides a management and control channel between communication interfaces 918 and 920 across a logical boundary 924 between control hardware 904 and optical hardware 902.

As discussed above, bridging optical cables 518 provide multiple paths for data flow, such as to achieve redundancy and/or load balancing. Some embodiments of communication networks 500 and 600 are configured to (a) determine a plurality of possible paths of data in the communication network, e.g. where each possible path includes a bridging optical cable 518 instance, (b) select one or more of the plurality of possible paths according to at least one predetermined criteria, and (c) implement flow of data through the selected one or more possible paths by controlling optical switches accordingly. This procedure is performed, by example, by network hub 506, such as by processor 906 executing instructions 910 stored in memory 908 (FIG. 9). In some embodiments, network hub 506 randomly selects a plurality of possible paths using a random graph generation technique, such as using a Erdős-Renyi random graph model, and network hub 506 may evaluate the possible paths using a graph optimization technique such as a max-flow min-cut technique or a Ford-Fulkerson method. The predetermined criteria may include, for example, a shortest communication path (e.g. path with fewest path segments), a lowest-latency communication path, a highest-bandwidth communication path, a least-congested communication path, a communication path that achieves a predetermined redundancy, etc.

As one example of this procedure, assume again that trunk optical cable 512(1) fails at point A FIG. 5. In certain embodiments, network hub 506 determines a plurality of alternative paths for each optical node 510 affected by the failure. Table 1 below is an example of possible paths for optical node 510(1) that could be determined by network hub 506 in response to the failure at point A, where “S” refers to a path segment:

TABLE 1
Possible Alternative Paths for Optical Node 510(1)

| Path | S 1 | S 2 | S 3 | S 4 | S 5 | S 6 | S 7 | S 8 |
|---|---|---|---|---|---|---|---|---|
| A | 514(1) | 514(3) | 518(4) | 514(4) | 512(1) | | | |
| B | 514(1) | 514(3) | 518(3) | 514(4) | 512(1) | | | |
| C | 518(1) | 514(12) | 512(3) | | | | | |
| D | 514(1) | 514(2) | 518(2) | 514(12) | 512(3) | | | |
| E | 518(1) | 514(12) | 514(10) | 518(7) | 514(9) | 512(2) | | |
| F | 514(1) | 514(3) | 518(3) | 514(4) | 514(6) | 518(5) | 514(7) | 512(2) |

In the example of Table 1, network hub 506 determines six possible paths (paths A-F) to route data between optical node 510(1) and network hub 506 in response to the failure at point A. However, the paths listed in Table 1 do not represent all possible paths between optical node 510(1) and network hub 506. Network hub 506 could be configured to determine a different number of possible paths. In general, the more possible paths that network hub 506 determines for a given optical node, the greater the likelihood that an optimal path will be found. On the other hand, the more possible paths that network hub 506 determines for a given optical node, the greater the computing resources required by network hub 506. Therefore, the number of possible paths determined by network hub 506 may be selected to achieve a desired trade-off between optimal path determination and conservation of computing resources in network hub 506.

In the example of Table 1, network hub 506 selects one of paths A-F according to at least one predetermined criteria. Assume, for example, that the predetermined criterium is fewest number of path segments. Path C in Table 1 has the fewest path segments, and network hub 506 would accordingly select path C. Network hub 506 would then control optical switch 508(4) to implement path C, i.e. to cause data flow between optical node 510(1) and network hub 506 to be routed via bridging optical cable 518(1), ISA optical cable 514(12), and trunk optical cable 512(3). As another example, assume that the predetermined criterium is lowest latency, and network hub 506 determines path A to have lowest latency. Network hub 506 would accordingly select path A, and network hub 506 would then control optical switches 508(1) and 508(2) to implement path A, i.e. to cause data flow between optical node 510(1) and network hub 506 to be routed via ISA optical cable 514(1), ISA optical cable 514(3), bridging optical cable 518(4), ISA optical cable 514(4), and trunk optical cable 512(1).

The criteria whereby all impacted optical child nodes 510 establish connectivity by selecting the shortest path to an alternate network, as the example in selecting path C, provide an alternate connectivity path that traverses only a single optical switch 508, on its way of reaching the hub 506. This criteria requires signals to remain in the optical domain, avoiding transitions from optical to electrical domain, and minimizing optical switch transition delays, improving latency and reliability. A larger number of optical child nodes 510 would result if fiber penetrates even deeper. For this larger number of optical child nodes 510, many more bridging connection paths 518 to other networks would be available. This large number of bridging connection paths 518 distribute the load in case of failure and only requires minimal standby extra capacity in case a failure occurs as the load is distributed across many alternate paths. A network following this criteria along with optical switches, deeper child nodes and bridging paths leads to a redundant network topology that resembles the human circulatory system.

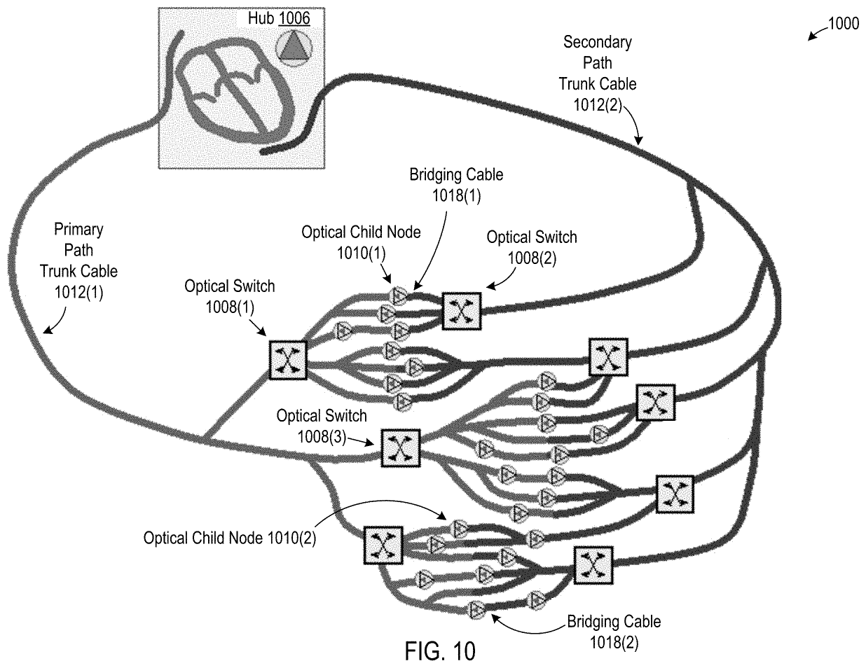

For example, FIG. 10 is a schematic diagram of a communication network including 1000, which is another embodiment of a communication network including serving area bridging connections. Communication network 1000 includes a network hub 1006, optical switches 1008, optical child nodes 1010, trunk cables 1012, and bridging cables 1018, which are analogous to network hub 506, optical switches 508, optical nodes 510, trunk optical cables 512, and bridging optical cables 518, respectively. Only some instances of optical switches 1008, optical child nodes 1010, and bridging cables 1018 are labeled to promote illustrative clarity. The redundant network topology achieved by bridging cables 1018 causes communication network 1000 to resemble a human circulatory system, as symbolically shown by network hub 1006 including an image of a heart.

As another example related to Table 1 and FIG. 5, assume that the predetermined criterium is maximum data flow rate between optical node 510(1) and network hub 506, and network hub 506 determines, e.g. using a Ford-Fulkerson algorithm, that path F has the maximum data flow rate, even though path F has the most segments of the six paths. Network hub 506 would accordingly select path F, and network hub 506 would then control optical switches 508(1)-508(3) to implement path F, i.e. to cause data flow between optical node 510(1) and network hub 506 to be routed via ISA optical cable 514(1), ISA optical cable 514(3), bridging optical cable 518(3), ISA optical cable 514(4), ISA optical cable 514(6), bridging optical cable 518(5), ISA optical cable 514(7), and trunk optical cable 512(2).

As another example related to Table 1, assume that (1) the predetermined criterium is that the selected path itself has the highest-level of redundancy, e.g. greatest number of alternative paths, and (2) network hub 506 uses a random graphing technique to determine that path D has the highest-level of redundancy. Network hub 506 would accordingly select path D, and network hub 506 would then control optical switches 508(1) and 508(4) to implement path D, i.e. to cause data flow between optical node 510(1) and network hub 506 to be routed via ISA optical cable 514(1), ISA optical cable 514(2), bridging optical cable 518(2), ISA optical cable 514(12), and trunk optical cable 512(3).

In some embodiments, optical switches 508 and 1008 are configured to automatically reroute data, e.g. without being controlled by network hub 506 or 1006, in response to an anomaly in communication network 500, 600, or 1000. For example, in some embodiments, optical switches 508 are configured to reroute data between ISA optical cables 514 communicatively coupled thereto in response to failure of a trunk optical cable 512 serving the optical switch. As another example, in some embodiments, optical switches 1008 are configured to reroute data in response to failure of a trunk cable 1012 communicatively coupled thereto.

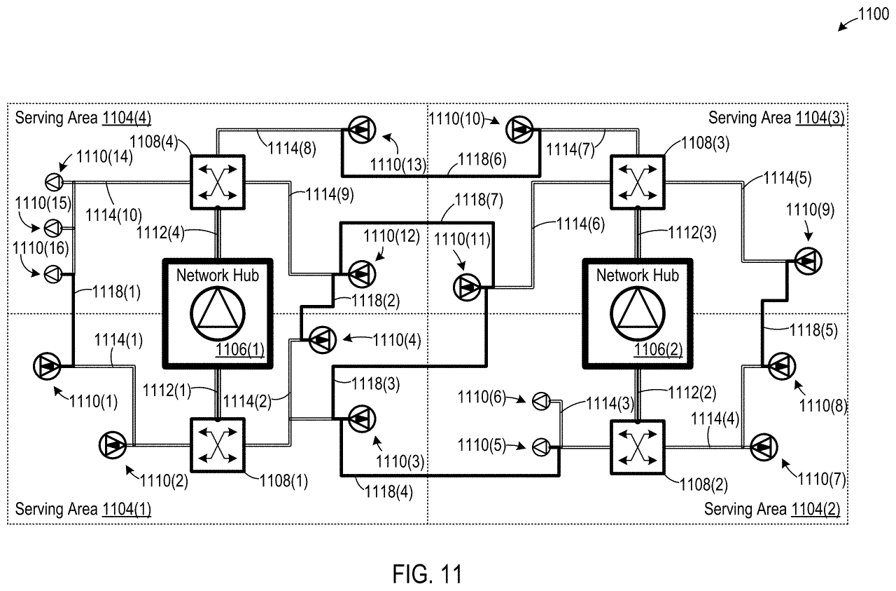

Bridging connections are not limited to communication networks with a single network hub. To the contrary, bridging connections could be incorporated in communication networks including multiple hubs, or even to connect two more separate communication networks. For example, FIG. 11 is a schematic diagram of a communication network 1100, which is one embodiment of the new communication networks including bridging connections and a plurality of network hubs. Communication network 1100 provides communication services to client nodes (not shown in FIG. 11) in a plurality of serving areas 1104. Serving areas 1104 are delineated by dashed lines in FIG. 11. Each serving area 1104 corresponds to a certain geographic area, such as a certain area of land or a certain portion of a building. Although FIG. 11 illustrates communication network 1100 providing service to four serving areas 1104, the number of serving areas 1104 served by communication network 1100 could vary without departing from the scope hereof. In some embodiments, serving areas 1104 are non-overlapping, such as illustrated in FIG. 11. In some other embodiments, serving areas 1104 may at least partially overlap, such to provide service to a critical client node from two different serving areas.

Communication network 1100 includes two network hubs 1106, a plurality of optical switches 1108, a plurality of optical nodes 1110, a plurality of trunk optical cables 1112, a plurality of ISA optical cables 1114, and a plurality of bridging optical cables 1118. Each network hub 1106 is analogous to network hub 506 of FIGS. 5 and 6, and each optical switch 1108 is analogous to optical switches 508 of FIGS. 5 and 6. Optical nodes 1110(1)-1110(4) and 1110(7)-1110(13) are analogous to optical nodes 510 of FIGS. 5 and 6. Electric cables communicatively coupling optical nodes 1110(1)-1110(4) and 1110(7)-1110(13) to client nodes are not shown in FIG. 11 for illustrative clarity. Optical nodes 1110(5), 1110(6), and 1110(14)-1110(16) are analogous to optical nodes 610 of FIG. 6.

Trunk optical cables 1112 are analogous to trunk optical cables 512 of FIGS. 5 and 6, and trunk optical cables 1112 communicatively couple network hubs 1106 to optical switches 1108. ISA optical cables 1114 are analogous to ISA optical cables 514 of FIGS. 5 and 6 and ISA optical cables 1114 communicatively couple optical nodes 1110 to optical switches 1108. Bridging optical cables 1118 are analogous to bridging optical cables 518 of FIGS. 5 and 6, and each bridging optical cable 1118 communicatively couples an ISA optical cable 1114 of one serving area 1104 and an ISA optical cable 1114 of another serving area 1104. The number of bridging optical cables 1118 and their topology may vary without departing from the scope hereof, as long as communication network 1100 includes at least one bridging optical cable 1118. Additionally, bridging optical cables 1118 could be replaced with alternative bridging connections, e.g. bridging electrical cables or bridging wireless links, without departing from the scope hereof.

Bridging optical cables 1118 provide a path for data to flow between serving areas 1104, and bridging optical cables 1118 can therefore provide redundancy and/or load balancing in a manner similar to that discussed above with respect FIGS. 5 and 6. Additionally, bridging optical cables 1118 advantageously enable each serving area 1104 access to two different network hub 1106 instances, such as to provide redundancy in the event of a network hub 1106 failure and/or to balance load on network hubs 1106. For example, serving areas 1104(1) and 1104(4) are primarily served by network hub 1106(1), and serving areas 1104(2) and 1104(3) are primarily served by network hub 1106(2). Assume that network hub 1106(1) fails. Bridging optical cables 1118(3), 1118(4), 1118(7) and 1118(8) provide paths between serving areas 1104(1) and 1104(4) and serving areas 1104(2) and 1104(3), thereby enabling serving areas 1104(1) and 1104(4) to use network hub 1106(2) in case of failure of network hub 1106(1).

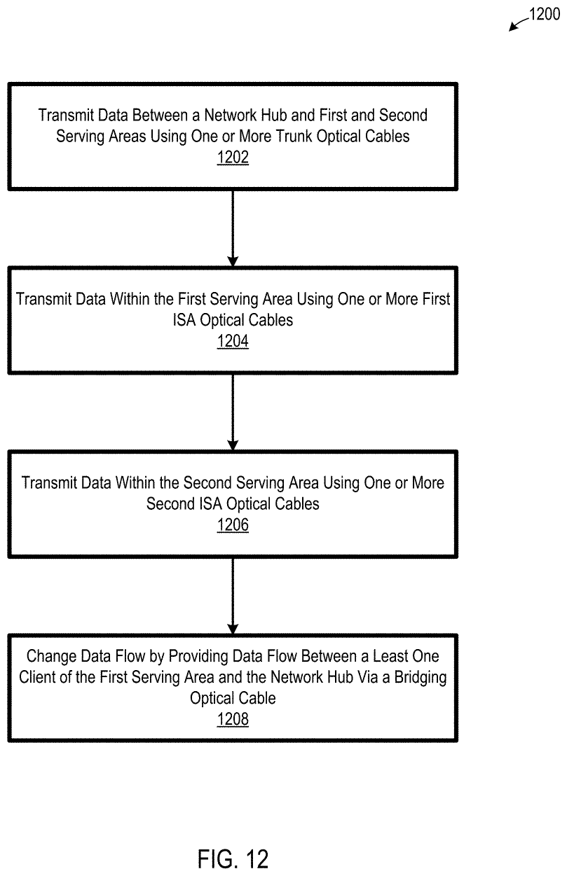

FIG. 12 is a flowchart illustrating a method 1200 for controlling flow of data in a communication network. In a block 1202, data is transmitted between a network hub and first and second serving areas using one or more trunk optical cables. In one example of block 1202, data is transmitted between network hub 506 and serving areas 504(1) and 504(2) using trunk optical cable 512(1) [FIG. 5 or 6]. In another example of block 1202, data is transmitted between network hub 1106(1) and serving areas 1104(1) and 1104(2) using trunk optical cables 1112(1) and 1112(4), respectively. In a block 1204, data is transmitted within the first serving area using one or more first ISA optical cables. In one example of block 1204, data is transmitted within serving area 504(1) using ISA optical cables 514(1)-514(3) [FIG. 5 or 6]. In another example of block 1204, data is transmitted within serving area 1104(1) using ISA optical cables 1114(1) and 1114(2).

In a block 1206, data is transmitted within the second serving area using one or more second ISA optical cables. In one example of block 1206, data is transmitted within serving area 504(2) using ISA optical cables 514(4)-514(6) [FIG. 5 or 6]. In another example of block 1206, data is transmitted within serving area 1104(4) using ISA optical cables 1114(8)-1114(10). In a block 1208, flow of data within the communication network is changed by providing flow of data between at least one client of the first serving area and the network hub via a bridging optical cable communicatively coupling the one or more first ISA optical cables and the one or more second ISA optical cables. In one example of block 1208, data flow in communication network 500 or 600 is changed by providing flow of data between at least one client device 502 of serving area 504(1) and network hub 506 via bridging optical cable 518(3) and/or 518(4). In another example of block 1208, data flow in communication network 1100 is changed by providing flow of data between at least one client device of serving area 1104(1) and network hub 1106(1) via bridging optical cable 1118(1) and/or 1118(2).

Combinations of Features

Features described above may be combined in various ways without departing from the scope hereof. The following examples illustrate some possible combinations:

(A1) A communication network may include a first serving area, a second serving area, a network hub, one or more trunk optical cables, and a first bridging connection. The first serving area may include a first optical switch, a first optical node, and one or more first intra-serving-area (ISA) optical cables communicatively coupling the first optical node to the first optical switch. The second serving area may include a second optical switch, a second optical node, and one or more second ISA optical cables communicatively coupling the second optical node to the second optical switch. The one or more trunk optical cables may communicatively couple the first and second optical nodes to the network hub, and the first bridging connection may communicatively couple the one or more first ISA optical cables and the one or more second ISA optical cables.

(A2) In the communication network denoted as (A1), the first bridging connection may include a first bridging optical cable.

(A3) In the communication network denoted as (A2), the first bridging optical cable may at least partially follow a different physical path than the one or more trunk optical cables.

(A4) In any one of the communication networks denoted as (A2) and (A3), the first optical switch may be configured to control flow of data through the first bridging optical cable.

(A5) In any one of the communication networks denoted as (A2) through (A5), the first optical switch may be configured to redirect flow of data from the one or more trunk optical cables to the first bridging optical cable in response to an anomaly in the communication network.

(A6) In any one of the communication networks denoted as (A2) through (A5), the first optical switch may be configured to divide flow of data between the one or more trunk optical cables and the first bridging optical cable in response to an anomaly in the communication network.

(A7) In any one of the communication networks denoted as (A2) through (A6), the first optical node may be communicatively coupled to each of the one or more first ISA optical cables and the first bridging optical cable via a bidirectional drop.

(A8) In any one of the communication networks denoted as (A1) through (A7), the first serving area may further include one or more electrical cables communicatively coupling client nodes to the first optical node.

(A9) In the communication network denoted as (A8), the one or more electrical cables may include one or more coaxial electrical cables.

(A10) In the communication network denoted as (A9), the network hub may include a cable headend.

(A11) In the communication network denoted as (A8), the one or more electrical cables may include one or more twisted-pair electrical cables.

(A12) In the communication network denoted as (A11), the network hub may include a telecommunications central office.

(A13) In any one of the communication networks denoted as (A1) through (A7), the network hub may include a wireless communication network core.

(A14) In any one of the communication networks denoted as (A1) through (A7), the first optical node may be an optical network terminal (ONT).

(B1) A method for controlling flow of data in a communication network may include (1) transmitting data between a network hub and first and second serving areas using one or more trunk optical cables, (2) transmitting data within the first serving area using one or more first intra-serving-area (ISA) optical cables, (3) transmitting data within the second serving area using one or more second ISA optical cables, and (4) changing flow of data within the communication network by providing flow of data between at least one client of the first serving area and the network hub via a bridging optical cable communicatively coupling the one or more first ISA optical cables and the one or more second ISA optical cables.

(B2) The method denoted as (B1) may further include changing flow of data within the communication network in response to an anomaly in the communication network.

(B3) Any one of the methods denoted as (B1) and (B2) may further include (1) determining a plurality of possible paths of data in the communication network, at least one of the plurality of possible paths including the bridging optical cable, (2) selecting one of the plurality of possible paths according to at least one predetermined criteria, and (3) implementing flow of data through the one of the plurality of possible paths.

(B4) In the method denoted as (B3), the at least one predetermined criteria may include at least one of a shortest communication path, a lowest-latency communication path, a highest-bandwidth communication path, a least-congested communication path, and a communication path that achieves a predetermined redundancy.

(B5) In any one of the methods denoted as (B3) and (B4), determining the plurality of possible paths of data in the communication network may include determining the plurality of possible paths at least partially using a random graph generation technique.

(B6) In any one of the methods denoted as (B1) through (B5), changing flow of data within the communication network may include changing configuration of an optical switch within the communication network.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A communication network, comprising:
a first serving area, including:
a first optical switch,
a first optical node, and
one or more first intra-serving-area (ISA) optical cables communicatively coupling the first optical node to the first optical switch;
a second serving area, including:
a second optical switch,
a second optical node, and
one or more second ISA optical cables communicatively coupling the second optical node to the second optical switch;
a network hub;
one or more trunk optical cables communicatively coupling the first and second optical switches to the network hub; and
a first bridging connection communicatively coupling the one or more first ISA optical cables and the one or more second ISA optical cables.

2. The communication network of claim 1, wherein the first bridging connection comprises a first bridging optical cable.

3. The communication network of claim 2, wherein the first bridging optical cable at least partially follows a different physical path than the one or more trunk optical cables.

4. The communication network of claim 2, wherein the first optical switch is configured to control flow of data through the first bridging optical cable.

5. The communication network of claim 2, wherein the first optical switch is configured to redirect flow of data from the one or more trunk optical cables to the first bridging optical cable in response to an anomaly in the communication network.

6. The communication network of claim 2, wherein the first optical switch is configured to divide flow of data between the one or more trunk optical cables and the first bridging optical cable in response to an anomaly in the communication network.

7. The communication network of claim 2, wherein the first optical node is communicatively coupled to each of the one or more first ISA optical cables and the first bridging optical cable via a bidirectional drop.

8. The communication network of claim 1, wherein the first serving area further includes one or more electrical cables communicatively coupling client nodes to the first optical node.

9. The communication network of claim 8, wherein the one or more electrical cables comprise one or more coaxial electrical cables.

10. The communication network of claim 9, wherein the network hub comprises a cable headend.

11. The communication network of claim 8, wherein the one or more electrical cables comprise one or more twisted-pair electrical cables.

12. The communication network of claim 11, wherein the network hub comprises a telecommunications central office.

13. The communication network of claim 1, wherein the network hub comprises a wireless communication network core.

14. The communication network of claim 1, wherein the first optical node is an optical network terminal (ONT).

15. The communication network of claim 1, wherein the first bridging connection bridges the first serving area and the second serving area.

16. A communication network, comprising:
a network hub;
a first serving area served by the network hub, the first serving area including:
a first optical node, and
a first client node served by the first optical node; and
a bridging connection communicatively coupling the first serving area to a second serving area served by the network hub, the bridging connection capable of providing an alternative path for communication between (a) the first client node served by the first optical node and (b) and the network hub, via the second serving area.

17. The communication network of claim 16, wherein the bridging connection comprises an optical cable between the first serving area and the second serving area.

18. The communication network of claim 16, wherein the bridging connection is configured to communicatively couple the first serving area and the second serving area by enabling optical signals to travel between the first serving area and the second serving area without the optical signals being converted to electrical signals.

19. A communication network, comprising:
a network hub;
a first serving area comprising a plurality of first optical nodes communicatively coupled to the network hub such that first signals exchanged between the network hub and the plurality of first optical nodes remain within an optical domain while being transmitted between the network hub and the plurality of first optical nodes;
a second serving area comprising a plurality of second optical nodes communicatively coupled to the network hub such that second signals exchanged between the network hub and the plurality of second optical nodes remain within the optical domain while being transmitted between the network hub and the plurality of second optical nodes; and
a bridging connection configured to provide an alternative path for exchange of third signals between (a) the plurality of first optical nodes and (b) the network hub, via the second serving area, such that the third signals remain within the optical domain while being transmitted between the plurality of first optical nodes and the network hub.

20. The communication network of claim 19, wherein each of the first serving area and the second serving area comprises a different respective geographic area served by the network hub.
